(19) United States
(12) Patent Application Publication
(10) Pub. No.: US 2026/0329236 A1
(43) Pub. Date: Oct. 22, 2026

(54) Method for generating at least one rule for a safety filter module of an industrial network

(71) Applicant: Robert Bosch GmbH, Stuttgart (DE)

(72) Inventors: Abdulkadir Karaagac, Renningen (DE); Jan Hoffmann, Pforzheim (DE); Marie-Theres Suer, Braunschweig (DE)

(21) Appl. No.: 19/545,355

(22) Filed: Feb. 20, 2026

(30) Foreign Application Priority Data
Feb. 21, 2025 (DE) 10 2025 106 603.5

(51) Int. Cl. G05B 9/02

(52) U.S. Cl. CPC G05B 9/02

(57) ABSTRACT

A method is for generating at least one rule for a safety filter module of an industrial network. The method includes providing security guidelines and compliance requirements of the industrial network, and determining a network structure of the industrial network based on an analysis of a communication of a network controller and/or a communication of individual devices of the industrial network. The method further includes generating the at least one rule for the safety filter module of the industrial network based on the provided security guidelines, the compliance requirements, and the determined network structure.

The invention relates to a method for generating at least one rule for a safety filter module of an industrial network. The invention further relates to a computer program, a device, and a storage medium for this purpose.

### PRIOR ART

Safety filter modules such as firewalls are generally recognized as critical components for protecting systems from unauthorized access and cyber threats. They play an important role in filtering network traffic, preventing data leaks, and maintaining the integrity of critical operations. However, with the rapid advancement in technology and increasing need for efficiency, the demand for more modular and flexible safety filter module implementations is increasing. This paradigm shift presents new challenges and requirements for network and security measures, especially in real-time environments.

Additionally, manual effort in safety filter module configuration and rule creation often proves to be time consuming and inefficient, preventing companies from effectively protecting their networks. In addition, the dynamic nature of network environments presents a major challenge, as it becomes increasingly difficult to keep up with constant changes. This can lead to potential security gaps and operational inefficiencies, making systems vulnerable to attacks.

To address these challenges, tools and frameworks have been developed to simplify the management of safety filter module configurations. These solutions provide intuitive user interfaces for establishing security guidelines, creating safety filter module filter rules, and reviewing them. These advances have undoubtedly simplified the processes for configuring safety filter modules, but have not completely eliminated the need for manual input by operators with extensive knowledge of the systems and networks.

### DISCLOSURE OF THE INVENTION

The subject matter of the invention is a method having the features of claim 1, a computer program having the features of claim 8, a device having the features of claim 9, and a computer-readable storage medium having the features of claim 10. Further features and details of the invention result from the respective dependent claims, the description and the drawings. Features and details which are described in connection with the method according to the invention naturally also apply in connection with the computer program according to the invention, the device according to the invention, and the computer-readable storage medium according to the invention, and vice versa in each case, so that a reciprocal reference is always possible with regard to the disclosure of the invention.

The object of the invention is in particular a method for generating at least one rule for a safety filter module, in particular a firewall, or a plurality of safety modules, of an industrial network, for example a time-sensitive networking (TSN) network, comprising:
providing security guidelines and compliance requirements of the industrial network, wherein the security guidelines and compliance requirements specify in particular permitted data traffic and/or communication paths in the industrial network,
(automatedly) determining a network structure, comprising, for example, a topology and individual devices, such as machines, sensors, or actuators, of the industrial network based on an analysis of communication or data traffic of a network controller and/or communication or data traffic of individual devices of the industrial network, wherein it may be provided that a corresponding query is sent to the network controller or test messages to the individual devices in order to analyze the communication or the data traffic,
(automatedly) generating the at least one rule for the safety filter module of the industrial network based on the provided security guidelines and compliance requirements as well as the determined network structure.

By the method according to the invention, it may be advantageous to have the generation of the rules for the safety filter module, or firewall, be carried out automatedly and more efficiently. The method according to the invention may also be carried out analogously for a plurality of safety filter modules or all of the safety filter modules present in the industrial network. The method may be performed using a rule generation and verification module, which is in particular a software module. In the context of the provisioning, extensive application and service requirements may further be gathered (e.g., from the network controller or from the devices). security guidelines can each be specified individually, for example, for office networks, red/yellow/green networks, technical networks, or logistics networks. Compliance requirements may be based on device types, e.g., internal, private, or external company devices. The rules define in particular what type (e.g., data type, ports, . . . ) of packets are allowed through the safety filter module, i.e., in simplified terms, who is permitted to communicate with whom and how.

The network controller in the industrial network is in particular a central control unit that manages the data traffic and communications between the various individual devices. Possible functions of the network controller may include the following: A data transfer between machines, sensors, actuators, and control systems can be managed and optimized. In doing so, industrial communication protocols, such as Profinet, EtherNet/IP, Modbus TCP, or OPC UA, can be supported. Further, central control and coordination can occur, in particular monitoring and controlling network traffic to ensure reliable and deterministic communication. In addition, security management may be performed, for example, by implementing security guidelines (e.g., VLANs, firewalls, access controls). Protection against cyberattacks can also be provided through network segmentation and monitoring of data traffic.

Furthermore, in the context of the invention, it is contemplated that the provisioning comprises:
analyzing at least one standard and/or at least one system specification of the industrial network and/or individual devices of the industrial network.

Further, specific security guidelines and compliance requirements may also be dictated by customers or internally within the company. This allows a firm basis for generating the rules. Incorporating the standards and specifications can help to more accurately adjust the rules to the respective industrial network and reduce potential conflict situations through inconsistencies.

Optionally, it may be contemplated that determining the network structure comprises:
capturing network traffic in the industrial network, in particular using a simulated file,
analyzing the captured network traffic,
determining the individual devices in the industrial network and/or a spatial arrangement of the individual devices and/or respective addresses of the individual devices and/or respective subnets of the individual devices and/or ports used by the individual devices and/or data types used by the individual devices based on a result of the analysis.

The simulated file may be a Network Traffic Captures/Traces (PCAP) file by means of which, for example, typical processes in the industrial network can be replicated. Thus, the network structure of the industrial network may be determined by analyzing simulated or actual data traffic recordings. Information such as IP addresses, subnets, ports used, and communication protocols can be extracted to generate a detailed representation of the devices and their connections in the industrial network.

It can further be advantageously provided that the method further comprises:
reviewing the at least one generated rule with regard to a syntax and/or an order relative to further rules and/or redundancy with at least one further rule and/or a contradiction with at least one further rule and/or effectiveness.

In this way, when generating the rule, it can be ensured that it is correctly formulated, compatible with other rules, lacks redundancy or contradictions, and functions effectively.

Optionally, it may be provided that the method may further comprise:
implementing or initiating an implementation of the at least one generated rule on the safety filter module of the industrial network,
filtering or initiating filtering of traffic in the industrial network using the security filter module with the at least one implemented rule.

This allows the generated rule to be applied directly in the safety filter module of the industrial network, which can then filter the data traffic in real time. The implementation of the rules enables effective implementation of security guidelines and compliance requirements, taking into account the network structure.

A further advantage in the context of the invention is achievable if the following step is performed prior to implementing:
initiating an output to a user, wherein the output describes the at least one generated rule and requests approval by the user,
   wherein the implementing of the at least one generated rule is performed only when, after initiating the output, the approval is received from the user. This additional step may contribute to improving security and control in an application of the at least one generated rule. This step may allow the user to review and, if necessary, approve the at least one generated rule prior to implementation. This provides additional human verification and can reduce a risk of unintended misconfigurations.

In addition, it is advantageous for the method to further comprise:
monitoring data traffic in the industrial network and/or changes to a configuration, a status, and/or a performance of the safety filter module, wherein, when monitoring the data traffic, for example, anomaly detection may be performed,
generating at least one further rule for the safety filter module depending on a result of monitoring.

This has the advantage that the rules can be adjusted over time to changed conditions and so the security of the industrial network can be continuously improved. By monitoring the data traffic, for example, it may be determined whether there are any abnormalities or whether new devices or communication protocols have been added that have not been included in the original rule base. The same applies to changes to the safety filter module itself or changes in the status and performance of the safety filter module. Further rules may then be generated based on the monitoring result in order to continue to effectively protect the industrial network.

Another object of the invention is a computer program, in particular a computer program product, comprising instructions which, when the computer program is executed by at least one computer, cause the computer to carry out the method according to the invention. The computer program according to the invention thus brings about the same advantages as have been described in detail with reference to the method according to the invention.

The subject matter of the invention is also a device for data processing that is configured to execute the method according to the invention. The device can be at least one computer, for example, that executes the computer program according to the invention. The computer may have at least one processor for executing the computer program. A non-volatile data memory can be provided as well, in which the computer program can be stored and from which the computer program can be read by the processor for execution.

The invention can also relate to a computer-readable storage medium, which comprises the computer program according to the invention and/or commands that, when executed by at least one computer, prompt said computer program to carry out the method according to the invention. The storage medium is configured, for example, as a data memory such as a hard disk and/or a non-volatile memory and/or a memory card. The storage medium may, for example, be integrated in the computer.

Furthermore, the method according to the invention may also be executed as a computer-implemented method. Alternatively or additionally, at least one of the disclosed method steps may be computer-implemented and/or performed automatically.

Further advantages, features and details of the invention will be apparent from the following description, in which exemplary embodiments of the invention are described in detail with reference to the drawings. In this case, the features mentioned in the claims and in the description may in each case be essential to the invention individually or in any desired combination. They show:

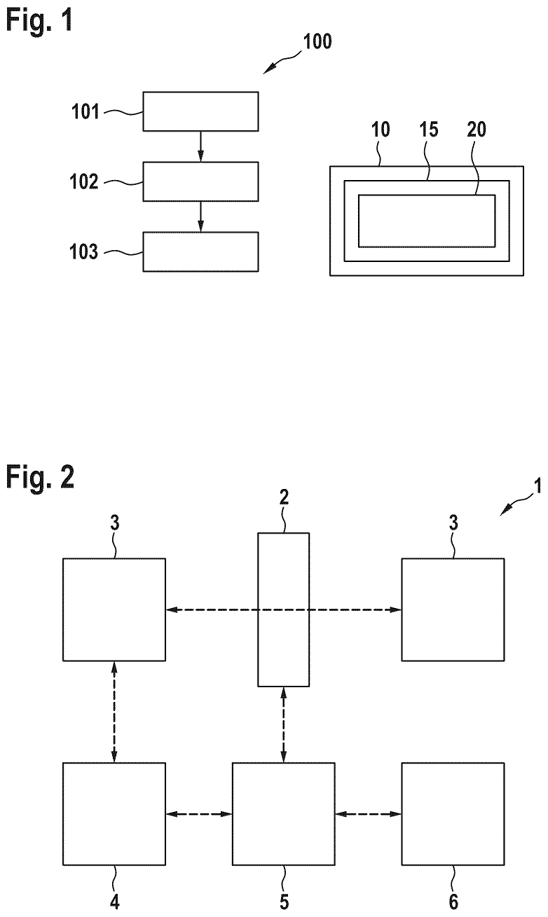

FIG. 1 a schematic visualization of a method, a device, a storage medium, and a computer program according to exemplary embodiments of the invention,

FIG. 2 a schematic illustration of an industrial network according to embodiment examples of the invention,

FIG. 1 schematically illustrates a method 100, a device 10, a storage medium 15, and a computer program 20 according to exemplary embodiments of the invention.

In particular, FIG. 1 shows an exemplary embodiment of a method 100 for generating at least one rule for a safety filter module 2 of an industrial network 1. In a first step 101, security guidelines and compliance requirements of the industrial network 1 are provided. In a second step 102, a network structure of the industrial network 1 is determined based on an analysis of communication of a network controller 4 and/or communication of individual devices 3 of the industrial network 1. In a third step 103, the at least one rule for the safety filter module 2 of the industrial network 1 is generated based on the provided security guidelines and compliance requirements as well as the determined network structure.

FIG. 2 shows a schematic representation of an industrial network 1 according to exemplary embodiments of the invention. The industrial network 1 includes two devices 3 that communicate via a safety filter module 2, in particular a firewall, i.e., traffic between the devices 3 is preferably filtered by the safety filter module 2. Furthermore, the industrial network 1 comprises a network controller 4 in communication with at least one device 3 to provide a configuration and/or analyze data traffic. Further, the industrial network 1 includes a rule generation and verification module 5, which may generate rules for the safety filter module 2 and implement them on the safety filter module 2. The rule generation and verification module 5 may further initiate outputs to a user 6 and receive approvals from the user 6.

According to the prior art, a fully automated security filter module configuration solution in particular is not yet provided that can continuously configure, monitor, and adjust rules based on real-time information along with information about a network structure, a system description, and applications executed behind the safety filter module 2. In particular, existing solutions are often unable to leverage this extensive knowledge to dynamically adjust rules before and during operation. As a result, safety filter module configurations are difficult to maintain and it is difficult to effectively protect industrial networks 1 from emerging threats.

In accordance with exemplary embodiments of the invention, in particular, a safety filter module configuration solution is provided, which, for example, overcomes the following deficiencies: The traditional approach of manually configuring and monitoring safety filter modules 2 may be time-consuming, error-prone, and inefficient. Further, only limited use can be made of network and system knowledge in the safety filter module configuration. In addition, there is a particular lack of adaptability to changing environments and operating conditions, which can result in outdated and ineffective safety filter module configurations. Manually managing rules for the safety filter modules 2 may be complex, particularly in large and dynamic network environments.

By addressing these specific challenges and deficiencies, the invention is directed in particular towards improving the process of safety filter module configuration by leveraging extensive knowledge of the network infrastructure, automating manual tasks, making adjustments to changing environments and conditions, and thus simplifying rule management. This may result in a more efficient and more secure safety filter module 2.

According to exemplary embodiments of the invention, an intelligent rule generation and verification module 5 (Firewall Rule Engine) may be used as part of the method. By utilizing extensive information about the network structure, application requirements, security guidelines, compliance requirements, and historical data, it can be possible to create highly customized rules and configurations. This level of customization can ensure optimal protection and efficiency in any network environment and can improve the way in which safety filter modules 2 are employed.

Advantages over the prior art include, for example, the following: The invention may eliminate the need for manual rule creation and/or review, saving a great deal of time and reducing the cost associated with labor-intensive configuration processes. The automated nature of the solution according to the invention can thus optimize the overall workflow of the safety filter module configuration. By utilizing intelligent analytics and comprehensive network information, the invention can enable accurate and precise generation of rules. This can reduce the risk of human error and misconfigurations and increase overall security. The invention is characterized, for example, by an ability to adjust to changing network conditions and system status and to continuously analyze and adjust rules in real time. Through the ability to perform historical rule analysis and network traffic analysis, the invention can enable a quick response to security threats. Patterns and anomalies in network traffic can be detected, thereby enabling immediate adjustment of the rules to minimize potential risks.

According to the method of the invention, in particular using the rule generation and verification module 5, the following steps, for example, are carried out: Important information about a network structure and topology (e.g., from a network controller 4), including layout, connectivity, and segmentation, may first be retrieved. Further, extensive application and service requirements may be gathered (e.g., from the network controller 4 or from devices 3) and required ports, protocols, and access requests determined. Additionally, knowledge of security guidelines and compliance requirements may be considered in order to collect historical rule analysis and network traffic analysis from safety filter modules 2. Finally, rules can be automatically generated as appropriate. These generated rules are thus tailored in particular to a specific network environment of the industrial network 1 and can ensure optimum protection and efficiency.

The rule generation and verification module 5 for performing the method may be hosted directly in a safety filter module 2 itself or provided on another device 3 connected to the industrial network 1, either locally or remotely. It may be critical to gather the required information and securely access safety filter modules 2 to exchange information and download configurations. This ensures that operators of the industrial network 1 have the freedom to choose the most appropriate deployment approach based on their specific network architecture and operational requirements.

First, in particular by means of the rule generation and verification module 5, compliance requirements can be identified and categorized based on device types. By analyzing a system description or a technical file, different types of devices in the industrial network 1 can be identified, e.g., internal, private, or external devices 3. Specific compliance requirements can apply for each type of device that must be met. For example, internal devices 3 may have stricter security guidelines as compared to external devices. These differences can be considered when creating the rules.

For example, security guidelines may be defined based on network types involved. Different types of networks have in particular different sensitivity and risk levels. For example, office networks may have different security guidelines than safer factory networks, engineering networks, or logistics networks. By extracting this information from the system description and the technical files, it can be ensured that the rules generated are consistent with the specific security guidelines (e.g., where communication may originate from and where it may go).

By automating the knowledge collection using safety guidelines and compliance requirements, manual analysis and interpretations can be eliminated.

According to exemplary embodiments of the invention, detailed information about the industrial network 1 may be obtained and a system assessment may be performed. By communicating with network controllers 4 and/or (end) devices 3, information about the network structure and/or topology as well as extensive application and service requirements may be collected.

To determine the information on the network structure and/or topology, at least one network controller 4 may be communicated with, such as a “Centralized Network Configuration” (CNC) element in TSN domains (“time-sensitive networking”) or SDN controllers (“software-defined networks”) in SDN networks. The CNC is responsible in particular for managing and controlling a network infrastructure and may therefore have complete information about the layout, configuration, and performance of the industrial network 1. In doing so, standardized interfaces of the CNC (User Network Interface (UNI)) can be used effectively to establish seamless communication with the CNC. By connecting to the network controller (e.g., a CNC or SDN controller), this essential information may be obtained that may be critical to understanding the network architecture and determining the appropriate placement (e.g., as close to the target end device as possible) of rules.

Likewise, according to the invention, communication may be established with terminals and/or a centralized user configuration (CUC) element within the TSN domain to capture extensive application and service requirements. For example, the CUC has knowledge of the applications and services running on the industrial network 1, including required ports, protocols, and access requirements. By interacting with the CUC, for example, this valuable information can be extracted to generate rules that are specifically tailored to the needs of the applications and services on industrial network 1.

Alternatively, network operators may be offered flexibility by allowing them to import network and system information in the form of an engineering or design file (e.g., in CAD, JSON, YANG, or NEMO format). This file may include detailed information about the network structure, topology, application requirements, and other relevant data. By importing this file, the operators may provide the required inputs for the system assessment process according to the invention. This information can be analyzed and utilized to generate rules that are tuned to the specific network environment.

After the system assessment is completed as described above, the rule creation phase can proceed. At this stage, for example, algorithms, artificial intelligence (AI), and machine learning (ML) may be used to create optimal safety filter module configurations. The rules creation process according to the invention includes, for example, an analysis of the network structure, application requirements, and security guidelines to ensure accuracy and adaptability of the rules created.

To create the rules, network entities can be associated with subnets. By understanding the network structure determined during the system assessment, various network entities present in the network environment may be identified. These entities can then be associated with their respective subnets, which can enable precise identification and control of data traffic within the industrial network 1.

In addition to mapping network entities to subnets, applications may be identified based on the protocol and ports they use. By analyzing the comprehensive application and service requirements captured during the system assessment, specific protocols and ports that each application needs for communication can be determined. This information is in particular critical to creating rules that allow or restrict traffic based on these protocols and ports, thereby ensuring secure and efficient communication between applications.

In addition, security guidelines are preferably considered during the rule creation process. By analyzing the security guidelines determined during the system assessment, it can be ensured that the rules generated comply with those guidelines. Factors such as network types (e.g., office networks, red/yellow/green networks, technical networks, logistics networks) may be considered and compliance requirements may be categorized based on device types (e.g., internal, private, or external company devices). By including these considerations, rules can be generated that are tailored to the specific security requirements of the network.

For example, the advanced algorithms, AI and ML technologies used allow large amounts of data to be analyzed efficiently and enable smart decisions to be made based on patterns and trends. Through continuous learning from historical rule analysis and network traffic, rule creation can be improved over time and adapt to changes in the network environment and evolving security threats.

In addition to the rule creation functions, according to exemplary embodiments of the invention, an automatic review is performed for automatically created and manually added rules. This review can ensure the integrity and/or effectiveness of the safety filter module configuration by evaluating various aspects such as syntax, order, redundancy, conflicts, and overall effectiveness.

During the rule review, various aspects of the rules can be assessed to ensure their integrity and effectiveness. The following is an exemplary description of what types of reviews may be performed. The rules may be subject to syntax reviews to ensure that the rules conform to a required format and the syntax of a safety filter module configuration language. Thus, it can be ensured that the rules are correctly structured and can be understood and interpreted by the safety filter module 2. Further, an order of the rules may be reviewed. The order of the rules may have a significant impact on their effectiveness. By doing so, conflicts can be avoided and it can be ensured that the rules are evaluated in the desired order, which can enable efficient and accurate filtering of the data traffic. Further, redundant rules may be identified and marked. If a redundant rule is detected, it is preferably promptly eliminated or reported to a user 6 so that the user can take appropriate action. By detecting and eliminating redundancies, it can be ensured that only the necessary rules are present in the safety filter module configuration. Conflicting rules can lead to unpredictable behavior and compromise the effectiveness of the safety filter module 2. According to the invention, conflicts between rules may be identified by analyzing their parameters, conditions, and actions. In the event of a conflict, it can be solved by changing or reordering the rules to ensure consistent and coherent behavior. Further, the effectiveness of the rules may be assessed. The effectiveness of the rules will be assessed in particular in terms of achieving their intended purpose. This includes, for example, an analysis of the rules in the context of the network environment, application requirements, and security guidelines. By considering these factors, it can be ensured that the safety filter modules 2 are able to effectively filter and control the data traffic and ensure the desired level of security. reviewing the rules is preferably not a one-time procedure. The safety filter module configuration may be continuously monitored to detect changes or updates that could affect the effectiveness of the rules. This ongoing monitoring can ensure that the safety filter module 2 is in a reviewed and safe state even as the network evolves.

Further, it may be provided that not only automatically generated rules, but also manual rules and configurations will be reviewed by users 6. This means in particular that users 6 may have the flexibility to add or change rules manually as needed, and with the method according to the invention, the integrity and effectiveness of these manual rules may be reviewed along with the automatically generated rules. This feature allows, for example, full control over the configuration while ensuring that all rules are reviewed and comply with the desired security guidelines.

Once the rules and configuration are verified, an implementation may proceed according to two possible alternatives. According to a first alternative, the (reviewed) safety filter module configuration may be implemented directly on the safety filter modules 2 using configuration protocols such as NETCONF. In particular, this option ensures a seamless and automated process in which the verified rules are applied without manual intervention. According to a second alternative, approval may be obtained from a user 6, such as a safety filter module 2 or network operator, before the changes are applied to the safety filter module devices 2. In so doing, after reviewing the rules and configuration, a report or notification may be output describing the proposed changes. The report or notification can then be submitted for review and approval to the relevant user 6 or the operator or administrator. The changes or rules generated may be subsequently manually reviewed and the required approval granted before the configuration is implemented on the safety filter modules 2.

This flexibility in implementation options is beneficial, for example, when there are concerns about full automation and a manual review process is desired for additional security. For example, through the approval-based implementation, it can be ensured that potential risks or unintended consequences can be identified and addressed before the safety filter module configuration is applied.

Further, continuous monitoring and adjustment of the safety filter modules 2 of the industrial network 1 may be performed to ensure ongoing effectiveness and adaptability of the configuration to changes in the network structure, application requirements, and security guidelines. For this purpose, the safety filter module configuration (e.g., via NETCONF) may be continuously monitored for integrity and effectiveness, and notifications, for example, may be output in the event of inconsistencies. This can ensure alignment with the network structure, application requirements, and security guidelines. In addition, a safety filter module status 2 and a safety filter module performance may be monitored and potential bottlenecks or problems may be identified. In doing so, the safety filter module performance may be optimized for smooth network operation. It is also conceivable that data traffic in the industrial network 1 is analyzed to identify anomalies, thereby reducing security threats by adjusting the safety filter module configuration or guidelines.

A method, in particular an automated rule generation and verification process 5 for an industrial network 1 (e.g., TSN), according to the invention is described below.

In a first step, information about security guidelines and compliance requirements is collected. In a further step, communication is carried out with at least one network controller 4 and/or (end) devices 3 of the industrial network 1 to obtain information about the network structure and/or topology as well as comprehensive application and service requirements. In a further step, the safety filter module configuration, status (e.g., load), and performance (e.g., delays in packet processing) are monitored together with the network traffic. In a further step, rules are generated. In a further step, the automatically created or manually added rules are reviewed. In a further step, a user 6 may review and/or approve the rules before they are downloaded to and implemented on the safety filter modules 2. Once the rules have been reviewed and optionally approved by user 6, they can be downloaded to the automatically identified safety filter modules 2 in a further step and implemented there. In a further step, the downloaded rules are executed by the safety filter modules 2 to protect the industrial network 1.

Thereafter, regular updates, periodic reviews, and adjustments may be carried out to ensure ongoing effectiveness. In addition, the user 6 may access and monitor the configuration and status of the safety filter modules 2 via a user-friendly interface provided by the system.

A possible example of an application of the method according to exemplary embodiments of the invention will be described below. Consider a production plant with an automation network in which, for example, robotic machines and industrial controllers communicate via a fixed set of protocols and specific ports. This industrial network 1 exhibits in particular predictable, largely static traffic patterns, as each machine of the industrial network 1 performs repetitive tasks with minimal deviation. A network administrator as user 6 now wishes to ensure, for example, that only the necessary communication between the devices 3 takes place in order to protect the industrial network 1 from unauthorized or abnormal traffic.

Based on network traffic captures/traces (PCAP files, e.g., from a simulation that replicates the usual operations in the network), a number of rules may be generated in accordance with exemplary embodiments of the invention that allow only the exact traffic patterns that are seen in the capture files. Any other data traffic, including communication attempts over unauthorized ports or with unrecognized protocols, may be automatically blocked.

In a first step, the network structure may be determined, wherein preferably information is determined for each node, such as the respective IP addresses and subnets of the nodes. Furthermore, the respective role of each device 3 (e.g., PLC, robotic arm, sensor) may be determined, and each IP address may be assigned to a respective subnet. Further, communication requirements of each node may also be determined, such as protocols and ports (for example, Modbus/TCP 502 for a PLC robotic arm, UDP 7000 for a PLC sensor, etc.).

According to a further step, network traffic may be determined. To model the common network traffic, a simulated traffic capture (PCAP) file may be created, for example, by the user 6, by performing typical manufacturing operations. This simulation captures, by way of example, the three specific types of traffic required: a communication between node A and node B on TCP port 502 (Modbus protocol), a communication between node A and node C on UDP port 7000 (sensor data), and a communication between node D and node A on TCP port 8080 (HMI control commands).

In a further step, the rules may be generated. After loading the PCAP files, the captured traffic can be analyzed and a series of preliminary rules can be created that map the communication requirements of each node to specific protocols, ports, and subnets. Appropriate protocol and port identification, by way of example, might resemble the following: Between node A and node B, for example, the Modbus communication is identified on TCP port 502 that emanates from node A (IP1) and is directed to node B (IP2). Further, for example, UDP communication on port 7000 is identified between node A and node C (IP3). Also, for example, TCP communication on port 8080 between node D (IP4) and node A may be detected.

Between node A and node B, for example, a Programmable Logic Controller (PLC) could communicate with the robotic arm to control operations using the Modbus protocol over TCP port 502. For example, between node A and node C, the PLC, for example, could periodically review the sensor module for real-time data using UDP port 7000. Between node D and node A, an HMI terminal, for example, could send commands to the PLC via TCP port 8080 for manual control during maintenance. Such communication could be, for example, typical of this industrial network 1, which is designed for a fixed workflow in which robotic arms, sensors, and control interfaces interact predictably.

The analysis results can now be used to generate a set of rules that only allow for data traffic that exactly matches the captured communication patterns. The rules, for example, might resemble the following: Rule 1: Allow inbound TCP traffic on port 502 from IP1 (PLC) to IP2 (robot arm). Rule 2: Allow outgoing TCP traffic on port 502 from IP2 to IP1 to ensure response traffic from the robotic arm back to the PLC. Rule 3: Allow incoming UDP traffic on port 7000 from IP1 (PLC) to IP3 (sensor). Rule 4: Allow outgoing UDP traffic on port 7000 from IP3 to IP1 for responses from the sensor. Rule 5: Allow inbound TCP traffic on port 8080 from IP4 (HMI) to IP1 (PLC). Rule 6: Allow outgoing TCP traffic on port 8080 from IP1 to IP4 to process responses from the PLC back to the HMI. Rule 7: Blocking any other incoming and outgoing traffic not expressly permitted above.

The foregoing explanation of the exemplary embodiments describes the present invention exclusively in the context of examples. Of course, individual features of the embodiments can be freely combined with one another, if technically feasible, without leaving the scope of the present invention.

1. A method of generating at least one rule for a safety filter module of an industrial network, comprising:
providing security guidelines and compliance requirements of the industrial network;
determining a network structure of the industrial network based on an analysis of a communication of a network controller and/or a communication of individual devices of the industrial network; and,
generating the at least one rule for the safety filter module of the industrial network based on the security guidelines, the compliance requirements, and the network structure.

2. The method according to claim 1, wherein the analysis comprises:
analyzing at least one standard and/or at least one system specification of the industrial network and/or the individual devices of the industrial network.

3. The method according to claim 1, wherein the determining the network structure comprises:
detecting network traffic in the industrial network using a simulated file;
analyzing the network traffic; and
determining the individual devices in the industrial network, a spatial arrangement of the individual devices, respective addresses of the individual devices, respective subnets of the individual devices, ports used by the individual devices, and/or data types used by the individual devices based on a result of the analysis.

4. The method according to claim 1, further comprising:
reviewing the at least one rule in terms of syntax, an order relative to at least one further rule, redundancy with the at least one further rule, a contradiction with the at least one further rule, and/or effectiveness.

5. The method according to claim 1, further comprising:
implementing the at least one rule on the safety filter module of the industrial network; and
filtering data traffic in the industrial network using the safety filter module having the at least one rule.

6. The method according to claim 5, wherein prior to the implementing, the method comprises:
initiating an output to a user,
wherein the output describes the at least one rule,
wherein the output requests approval from the user, and
wherein implementing the at least one rule is performed only when, after initiating the output, the approval is received from the user.

7. The method according to claim 1, further comprising:
monitoring (i) data traffic in the industrial network and/or (ii) changes in a configuration, a status, and/or performance of the safety filter module; and
generating at least one further rule for the safety filter module based on a result of the monitoring.

8. The method according to claim 1, wherein a computer program comprises commands which, when the computer program is executed by at least one computer, cause the at least one computer to execute the method.

9. A device for data processing, comprising:
a processor configured to execute the method according to claim 1.

10. A non-transitory computer readable storage medium comprising instructions which, when executed by at least one computer, prompt the at least one computer to perform the method according to claim 1.
